(19) United States
(12) Patent Application Publication
(10) Pub. No.: US 2011/0139668 A1
(43) Pub. Date: Jun. 16, 2011

(54) PROTECTIVE DEVICES

(76) Inventor: Christopher Michael Baker, Sheffield (GB)

(21) Appl. No.: 13/003,079

(22) PCT Filed: Jul. 7, 2009
(86) PCT No.: PCT/GB2009/001685

§ 371 Date: Feb. 11, 2011

(30) Foreign Application Priority Data
Jul. 8, 2008 (GB) 0812426.5

(51) Int. Cl. B65D 81/07; B32B 38/04

(52) U.S. Cl. 206/521; 206/584; 229/87.02; 156/250

(57) ABSTRACT

The invention relates to protective devices for use in packaging and seeks to improve on known padded packaging and those employing deformable members such as plastics beads. The object of the invention is to provide packaging employing deformable members that can be manufactured employing conventional machinery. The object is met by a construction comprising a number of cushions of non-porous plastics material containing resiliently deformable members and connected together to enable an item to be protected to be embraced between the cushions, the connection between the cushions allowing movement of air between the cushions, and a valve in the outer face of one of the cushions, to enable air to be extracted from the cushions when an item is embraced between them and cause the resiliently deformable members to form into a rigid state.

This invention relates to protective devices for use in packaging and other applications where a protective covering would be beneficial for fragile items or items which could otherwise be damaged.

The most conventional and widely used method of protective packaging is termed the “jiffy” bag (JIFFY is a Registered Trade Mark), which has a cushioning layer inside a conventional envelope. However, such bags do not provide a high level of resistance to breakage and are susceptible to twisting and bending forces which may cause damage to objects placed inside the bag.

EP-A-0 460 942 describes a packaging sheet which comprises a sealed plastic envelope containing beads of blown polystyrene. The sheet has perforations so that when it is wrapped around an object to be packaged and pressure is applied, air is forced out of the envelope and the bead filling contracts and forms a fairly rigid protective sheath. However, this protective device is cumbersome to use and requires a sealed crate or box to compress the sheet after location around the object and such compression could damage the object around which the sheet is wrapped.

EP-A-1 236 655 discloses a protective device which comprises a fluid sealable envelope of a non-porous material having a plurality of resiliently deformable members (such as beads of blown polystyrene) therein, the envelope being designed to have a fluid evacuated state in which the plurality of resiliently deformable members form into an at least partial rigid state within the envelope to cause the resiliently deformable members to form a rigid barrier, and sealing means (such as a non-return valve) being provided to retain the envelope in the fluid evacuated state

The device may be in the form of a sheet to be wrapped around an object to be protected before fluid is evacuated therefrom; or it may be formed into a tube configuration to provide a protective sleeve.

Two such composite sheets may be superimposed and heat sealed along corresponding mating edges on three sides to form the walls of a bag or package in which objects may be protectively stored or transported. The interior sheet walls may be made of a porous material and closure means provided to seal the bag opening, whereby fluid evacuation through the porous inner walls causes both sheet envelope interiors and the interior of the bag or package to be evacuated, causing the porous inner walls to conform closely to the object to be protected, as well as the resiliently deformable members in each sheet to form rigid barriers.

Formation of such a bag, with or without porous interior walls, insertion of the resiliently deformable members, and provision of closure means to seal the bag, does not lend itself to production of the bag by conventional machinery feeding twin sheets of plastics and cross-welding them together intermittently.

The object of the invention is to provide a protective device in a form which overcomes this problem.

According to the present invention, a protective device for use in packaging comprises a number of cushions of non-porous plastics material containing resiliently deformable members and connected together to enable an item to be protected to be embraced between the cushions, the connection between the cushions allowing movement of air between the cushions, and a valve in the outer face of one of the cushions, to enable air to be extracted from the cushions when an item is embraced between them and cause the resiliently deformable members to form into a rigid state. The connection between the cushions may be a simple fold centrally of the non-porous plastics material forming the cushions, but preferably, the pair of cushions are hinged together with passageways through the hinge to allow movement of air between the cushions.

A method of producing protective devices comprises feeding two sheets of non-porous plastics material continuously through machinery in which one common pair of longitudinal edge portions are welded together continuously or, alternatively, feeding a single sheet folded lengthwise, and in either case intermittently cross-welding the sheets or the leaves of the folded sheet together, every other cross-weld being continuous and the intermediate cross-welds being interrupted to form the hinge and the passage means therethrough, shearing across each continuous cross-weld to create separate pairs of pockets hinged together and having openings along a common side, feeding the pairs of pockets through machinery in which the resiliently deformable members are inserted through the openings, to create the cushions and sealing the openings, the non-return valves having been applied to one of the sheets or to one leaf of the folded sheet in advance of entry into the welding and shearing machinery, and the cross-welding synchronised with the passing of the non-return valves appropriately. Preferably, the intermediate welds are interrupted in a plurality of places. Conventional machinery is available to effect the welding and shearing, insertion of the resiliently deformable members into the pockets, and welding of the openings to complete sealing of the cushions.

The resiliently deformable members are conveniently pre-packaged in permeable flexible enclosures, e.g. of plastics or paper, for ease of insertion into the pockets, particularly if the pockets are in horizontal disposition, as compared with having to direct the resiliently deformable members, e.g. as by gravity or blown, into pockets disposed vertically with the openings uppermost, and with possible difficulty in sealing the openings without disturbing the resiliently deformable members enough for some to be caught in the areas to be sealed and thus impairing the seals.

As the outer faces of cushions in direct contact with the enclosed resiliently deformable members or the faces of permeable flexible enclosures in which they are pre-packaged are liable to assume a pockmarked appearance, a stiffening (yet somewhat flexible) fascia board is preferably inserted adjacent each outer face of the pockets before or upon insertion of the resiliently deformable members whether pre-packaged or not, and the fascia boards for insertion adjacent each of the sheets or leaves with the non-return valves are pre-punched with holes to register therewith.

In the circumstance where the product to be transported has an appreciable depth in comparison with the depth of each of the cushions discussed above, or when a product that is particularly fragile needs to be transported, it is a further feature of the invention that the fascia in each cushion may be curved at its upper and lower edges, or may have a box-like construction to contain the product and allow it to be effectively surrounded by the resiliently deformable members that are confined around the product by the curved or box-like fascias.

Not only do fascias enhance the appearance of the outer faces of the cushions, they provide a strength that enables filled protective devices to be stacked for ease of storage and transportation.

The sheets or leaves of non-porous plastics material may be of equal lateral extent, in which case an enclosure may be provided for insertion therein of the protective device after an item to be protected has been embraced therein, to ensure that the item cannot slip out from between the cushions. The enclosure may be a resealably sealable bag or box, and may be provided with an aperture with which the non-return valve will register, to enable air extraction means (e.g. a manual suction pump) to be applied after insertion of the protective device and the item embraced therein. The non-return valve may be provided with means to enable it to be opened manually when it is required to admit air into the cushions to fluidise the resiliently deformable members ready for re-use of the protective devices and enclosures.

The enclosure, whether a bag or a box, may bear information relating to an item therein, thus rendering it unnecessary to apply any information to the protective device, which can, therefore, be used with a variety of items—of suitable size—information on which appears on the enclosure. However, a product card also bearing the relevant information may be provided with means for attachment of the item, which product card may also afford additional stiffening to the protective device, especially when the enclosure is a plastics bag; or an additional pocket may be formed by a pair of continuous cross-welds into which a product card can be inserted, and the additional pocket may be sealed if the protective device is to be re-used with the same type of item.

To ensure correct placement of an object to be packaged at least one of the cushions may have on one of its inner faces an array of adhesive material, continuous or discontinuous, encircling a space for location of an item to be packaged, whereafter the other cushion is closed to it to become adhered thereto, either by the use of double-sided self-adhesive material on the one pocket face or of hook-and-loop (e.g. Velcro—registered trade mark) on the respective mating faces of the pockets.

Alternatively, at least one of the cushions may have on one of its inner faces an array of adhesive material, (e.g. as above) continuous or discontinuous, disposed in a U-form, to which the other pocket is closed and becomes adhered before inserting an item to be packaged through the opening between the limbs of the U.

Again, one of the inner faces may be provided with an area of releasable adhesive to which an item can be adhered (provided the adhesive is not detrimental to the item), the area of adhesive being provided initially with a cover strip which is removable just before the item to be packaged is to be secured.

In order to provide a protective device that can be used independently of an enclosure, the sheets or leaves of non-porous material may be of different lateral extent so as to form a flap along one free edge of the cushion device, the other two free edges of the cushions (one opposite the hinge and the other opposite the flap or flaps) being welded to each other, to form a bag between the cushions, and the flap being provided with adhesive for sealing of the bag after insertion of an item to be protected. The flap is preferably resealable and the non-return valve provided with means to enable it to be opened manually, so that the protective device can be re-used.

Alternatively, if an additional pocket (for a product card) is formed by a pair of continuous cross-welds, this pocket may be provided with releasable adhesive to enable it to serve as a flap, and the non-return valve may be positioned so as to be covered by the closed flap.

Embodiments of the invention will now be described with reference to the following schematic drawings, it being understood that a plastics sheet or sheets and the formation of pockets can be performed on relatively conventional plastics sheet handling equipment.

In the drawings:

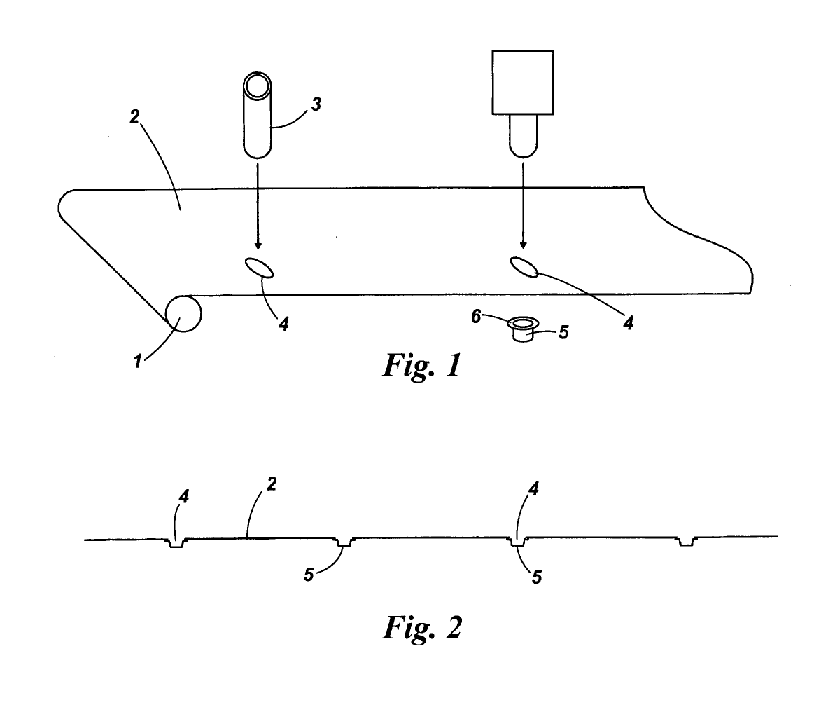

FIG. 1 shows the preparation of a sheet to receive a valve;

FIG. 2 is a side elevation of a sheet provided with spaced valves;

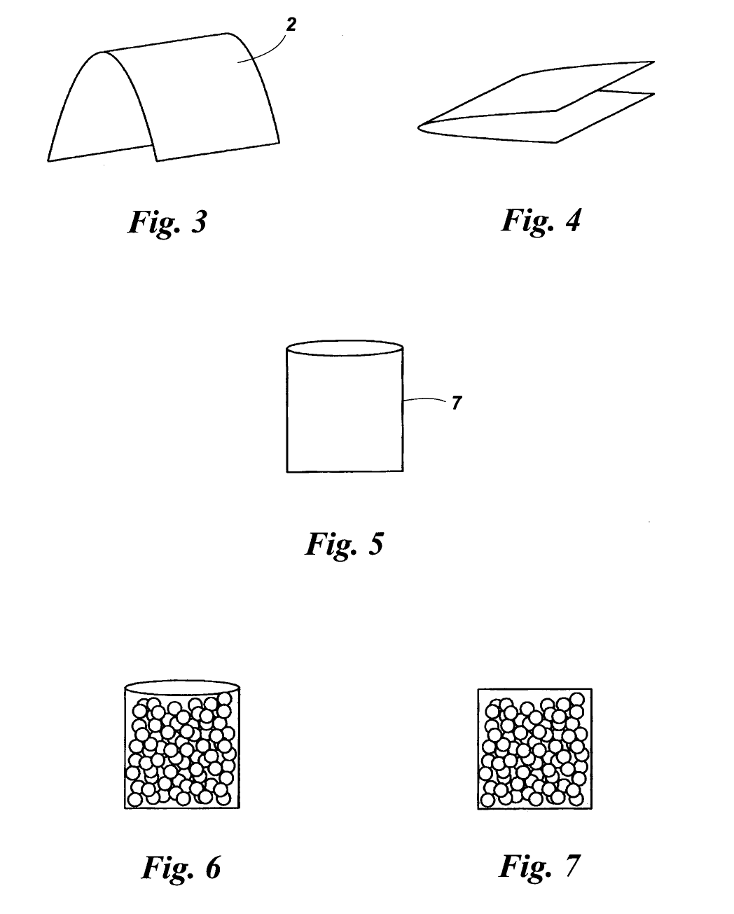

FIGS. 3 and 4 show the sheet of FIG. 1 first folded and then turned to position the folded sheet in a horizontal disposition;

FIGS. 5, 6 and 7 show a permeable flexible enclosure in an empty, filled and sealed condition respectively;

FIG. 8 shows the filled and sealed enclosures being transported for insertion between the leaves of the folded plastics sheet;

FIG. 9 shows the manner of provision of transverse welds across the sheets to formed filled pockets or cushions, and a closure flap, one weld being intermittent to provide air passages between the adjacent cushions;

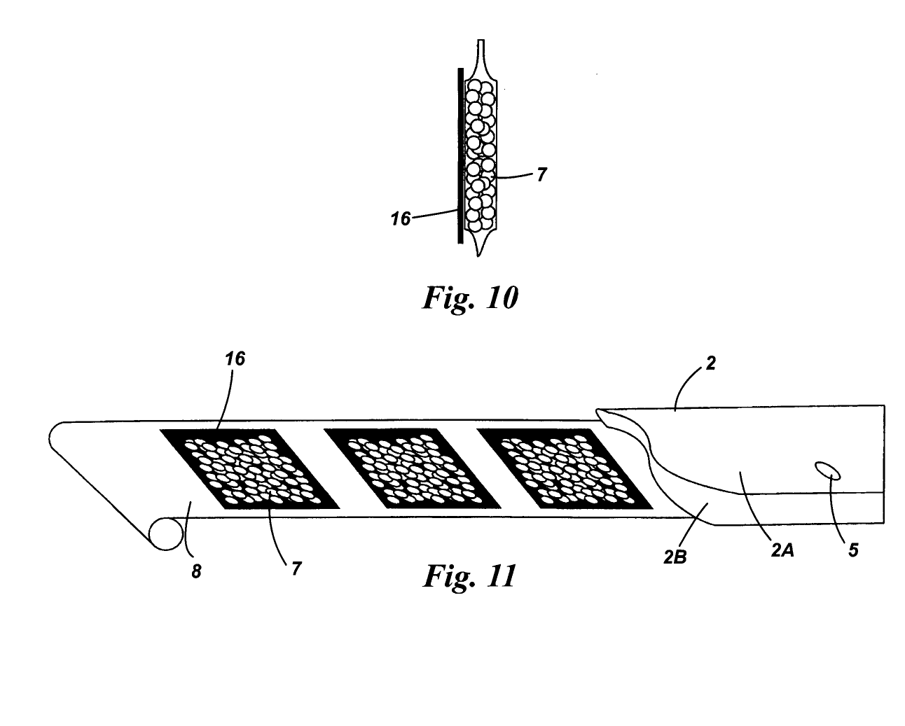

FIG. 10 corresponds to FIG. 8, but shows the filled and sealed enclosures positioned on a fascia board for insertion between the leaves of the folded sheet of plastics material;

FIG. 11 shows cushions in accordance with one embodiment of the invention positioned adjacent a product;

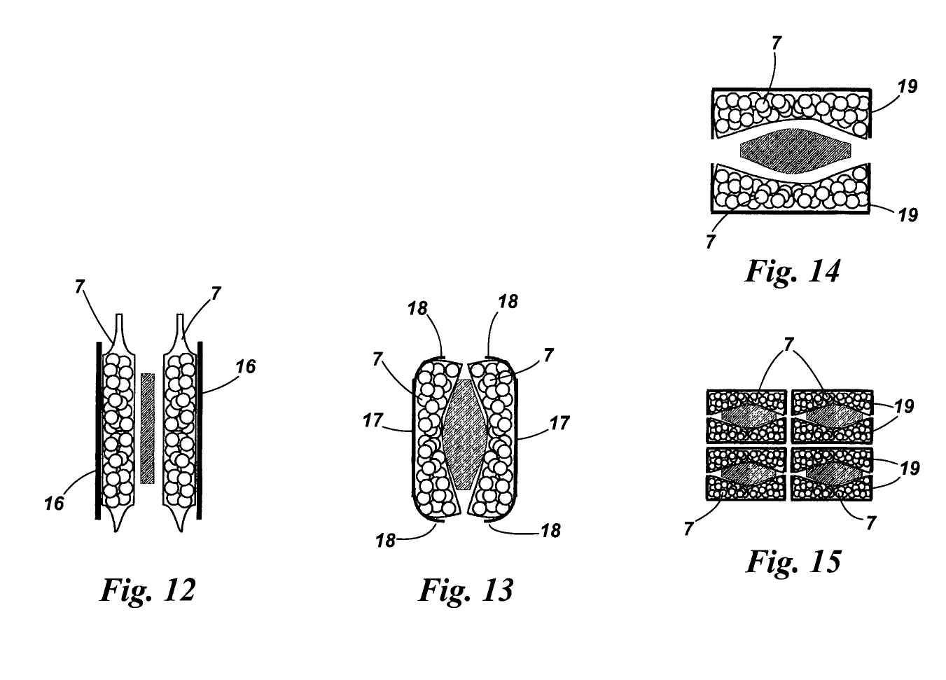

FIG. 12 corresponds to FIG. 11, but shows the use of curved fascia boards;

FIG. 13 corresponds to FIG. 11, but shows box-like fascia boards; and

FIG. 14 shows a number of devices according to FIG. 13 in a stacked condition for transport or storage.

FIG. 1 shows schematically a roll 1 of a plastics sheet 2, with the sheet being transported passed a punching station 3 where successive holes 4 are punched at the quarter distance across the sheet. Beyond the punching station, is a valve application station, where a valve 5 picked from a stack of valves is positioned on the lower face of the sheet in alignment with a hole 4, and a welding tool brought into contact with the edge of the hole to weld the sheet to an annular flange 6 on the valve. As a result, and as indicated in FIG. 2, a sheet with spaced valves is formed.

In conventional manner, and as illustrated in FIG. 3, the sheet 2 is folded about its centre line and then turned through 90° as is shown by FIG. 4, and the folded sheet laid on a support, as will be discussed later.

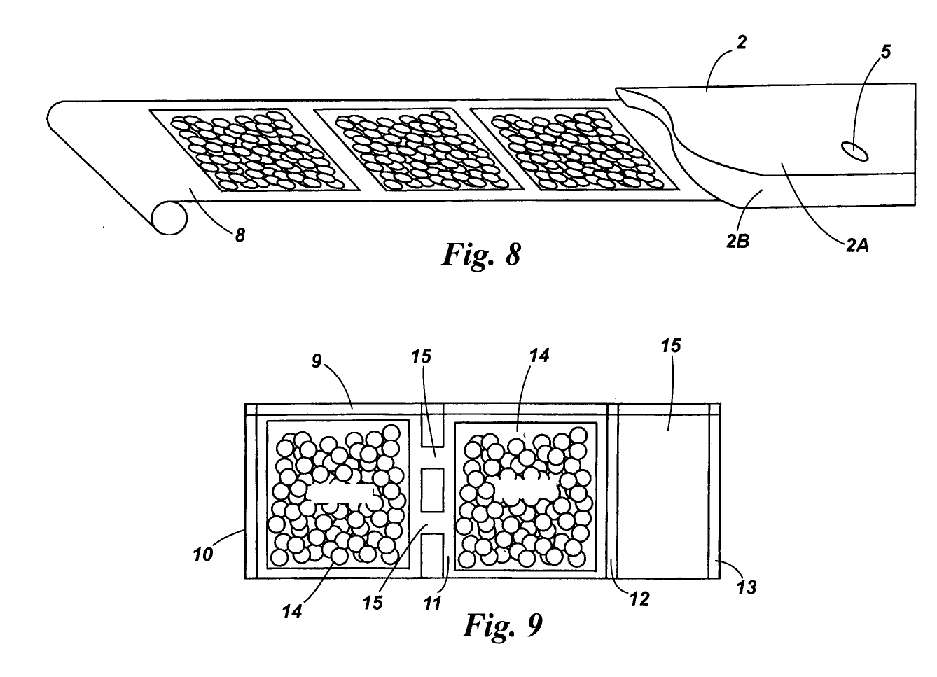

As is shown in FIG. 5, a permeable flexible enclosure 7 is provided, and in the known manner, is filled with resiliently deformable members, e.g. plastics beads, as shown in FIG. 6, with the opening to the enclosure welded as indicated in FIG. 7.

With filled enclosures fed to a conveyer means 8 (FIG. 8) above which the folded sheet 2 and its valves 5 is positioned, the filled enclosures can be fed between the leaves 2A and 2B of the sheet 2. As is indicated in FIG. 9, with two enclosures strategically positioned between the leaves 2A and 2B, the leaves can be subjected to horizontal welding at 9 to close the opened side of the folded sheet and subjected to transverse welding at 10, 11, 12 and 13 to create cushions 14 and a closure flap 15. The transverse welds 10, 12 and 13 extend completely across the folded sheet, by using such as a solid weld bar, but the weld 11 is formed with a series of unwelded sections 15, such as by using a notched weld bar, and such that there is a communication between the cushion interiors through the unwelded sections.

It will be apparent that the cushions 14 can be folded about the intermittent transverse weld 11 that serves as a hinge, to allow the cushions to be positioned on either side of an items to be protected, modest pressure on the cushions allowing the resiliently deformable members to mould, at least partially, around the object, and at which point, a suction means is applied to the valve, to extract air from both cushions to cause them to assume a rigid state, the flap 15 on one cushion 14, preferably provided with an adhesive strip at its free edge, can then be folded over the other cushion and secured to it by the adhesive strip.

The protective device discussed above is most effective in giving protection during transport and storage of fragile items or items that must not be scratched. However, the presence of such as plastics beads within the cushions can detract from the external visual appearance of the device, and in addition to this, it may be advantageous to provide additional protective means.

Therefore, and as is illustrated in FIG. 10, the pre-packed permeable flexible enclosure 7 can be provided with a relatively rigid board like member 16, and as is illustrated in FIG. 11, the board 16 and its enclosure 7 is laid on the conveyor 8 and fed between the leaves 2A, 2B of the folded sheet 2, to create the protective device following the procedure discussed in connection with FIGS. 8 and 9, but with the result that the outer face of each cushion is guaranteed to be plain and flat, for enhanced appearance, and the boards at the same time providing additional protection to the produce enclosed by the device, as is illustrated in FIG. 12, and its will be understood that each board 16 and its attendant permeable flexible enclosure 7 will be within a cushion in the manner of what is illustrated in FIG. 9.

As a still further feature of the invention, and to suit products that are of a relatively irregular shape, boards that are not folded may be employed. Thus, as is shown by FIG. 13, each board 17 may have curved outer edges 18, and each curved board and its permeable flexible enclosure 7 forming part of a hinged cushion, the device can be folded around a product, in an essentially similar manner as the device of FIG. 9, but with the board providing protection at each end of the device.

Equally possible is to form each board as an open box 19, with each box containing permeable flexible enclosure 7. Here, not only can the device be closed on to a product and the cushions evacuated, after the manner of the device of FIG. 9, but also is top, bottom and edge protection provided to a product between the enclosures 7, but also, and is indicated in FIG. 15, a number of protective devices can be stacked for ease of storage and transport.

1. A protective device for use in packaging comprising a number of cushions of non-porous plastics material containing resiliently deformable members and connected together to enable an item to be protected to be embraced between the cushions, the connection between the cushions allowing movement of air between the cushions, and a valve in the outer face of one of the cushions, to enable air to be extracted from the cushions when an item is embraced between them and cause the resiliently deformable members to form into a rigid state.

2. A protective device as in claim 1, wherein the connection between the cushions is a simple fold centrally of the non-porous plastics material forming the cushions.

3. A protective device as in claim 1, wherein the pair of cushions are hinged together with passageways through the hinge to allow movement of air between the cushions.

4. A protective device as in claim 1, wherein the resiliently deformable members are pre-packaged in permeable flexible enclosures for ease of insertion into the pockets.

5. A protective device as in claim 1, wherein a stiffening fascia board is inserted adjacent each outer face of the pockets before or upon insertion of the resiliently deformable members whether pre-packaged or not, and the fascia boards for insertion adjacent each of the sheets or leaves with the non-return valves are pre-punched with holes to register therewith.

6. A protective device as in any of claim 1, wherein each fascia board is curved at its ends to form a container for the resiliently deformable members to enable a product to be surrounded by the resiliently deformable members.

7. A protective device as in any of claim 1, wherein each fascia is formed as a box-like construction to form a container for the resiliently deformable members to enable a product to be surrounded by the resiliently deformable members.

8. A method of producing protective devices as in claim 3, comprising feeding two sheets of non-porous plastics material continuously through machinery in which one common pair of longitudinal edge portions are welded together continuously or, alternatively, feeding, a single sheet folded lengthwise, and in either case intermittently cross-welding the sheets or the leaves of the folded sheet together, every other cross-weld being continuous and the intermediate cross-welds being interrupted to form the hinge and the passage means therethrough, shearing across each continuous cross-weld to create separate pairs of pockets hinged together and having openings along a common side, feeding the pairs of pockets through machinery in which the resiliently deformable members are inserted through the openings, to create the cushions and sealing the openings, the non-return valve having been applied to one of the sheets or to one leaf of the folded sheet in advance of entry into the welding and shearing machinery, and the cross-welding synchronised with the passing of the non-return valves appropriately.

9. A method as in claim 8, wherein the intermediate welds are interrupted in a plurality of places.

10. A method as in claim 8, wherein the resiliently deformable members are pre-packed in permeable flexible enclosures for insertion in the pockets formed from the plastics sheet(s).

11. A method as in claim 8, wherein fascia boards are inserted into the pockets prior to the insertion of resiliently deformable members.

12. A method as in claim 11, wherein the fascia boards are shaped to provide enclosures for the resiliently deformable members, and whereby a product positioned between the cushions can be surrounded by resiliently deformable members.

13. A protective device as in claim 2, wherein the resiliently deformable members are pre-packaged in permeable flexible enclosures for ease of insertion into the pockets.

14. A protective device as in claim 3, wherein the resiliently deformable members are pre-packaged in permeable flexible enclosures for ease of insertion into the pockets.

15. A protective device as in claim 2, wherein a stiffening fascia board is inserted adjacent each outer face of the pockets before or upon insertion of the resiliently deformable members whether pre-packaged or not, and the fascia boards for insertion adjacent each of the sheets or leaves with the non-return valves are pre-punched with holes to register therewith.

16. A protective device as in claim 3, wherein a stiffening fascia board is inserted adjacent each outer face of the pockets before or upon insertion of the resiliently deformable members whether pre-packaged or not, and the fascia boards for insertion adjacent each of the sheets or leaves with the non-return valves are pre-punched with holes to register therewith.

17. A protective device as in claim 4, wherein a stiffening fascia board is inserted adjacent each outer face of the pockets before or upon insertion of the resiliently deformable members whether pre-packaged or not, and the fascia hoards for insertion adjacent each of the sheets or leaves with the non-return valves are pre-punched with holes to register therewith.

18. A protective device as in claim 2, wherein each fascia board is curved at its ends to form a container for the resiliently deformable members to enable a product to be surrounded by the resiliently deformable members.

19. A protective device as in claim 3, wherein each fascia board is curved at its ends to form a container for the resiliently deformable members to enable a product to be surrounded by the resiliently deformable members.

20. A protective device as in claim 4, wherein each fascia board is curved at its ends to form a container for the resiliently deformable members to enable a product to be surrounded by the resiliently deformable members.
